(19) United States
(12) Patent Application Publication
(10) Pub. No.: US 2026/0341253 A1
(43) Pub. Date: Oct. 29, 2026

(54) MEMBRANOPHONE AND SOUND MEMBRANE FOR A MEMBRANOPHONE

(71) Applicant: Elisabetta GOLTERMANN, Berlin (DE)

(72) Inventor: Elisabetta GOLTERMANN, Berlin (DE)

(21) Appl. No.: 19/117,928

(22) PCT Filed: Oct. 4, 2023
(86) PCT No.: PCT/EP2023/077485

§ 371 Date: Apr. 2, 2025

(30) Foreign Application Priority Data
Oct. 5, 2022 (DE) 10 2022 125 652.9

(51) Int. Cl. G10D 13/24; G10D 13/02; G10D 13/20

(52) U.S. Cl. CPC G10D 13/24; G10D 13/02; G10D 13/20

(57) ABSTRACT

The invention relates to a sound membrane for use in a membranophone for producing sounds, having a resonant surface, wherein the resonant surface has a first region with a first haptic surface structure, characterized in that the resonant surface has a second region, wherein the second region has a structure different from the first region, and in addition a membranophone for producing sounds having a body and a sound membrane, wherein the sound membrane comprises an elastic mesh fabric, and wherein the sound membrane is coated on one side, and to a method for producing a sound membrane and/or a membranophone.

The invention relates to a sound membrane for use in a membranophone for producing sounds with a resonant surface, wherein the resonant surface has a first region with a first haptic surface structure, and to a method for producing a sound membrane and/or a membranophone.

### PRIOR ART

Membranophones have a sound membrane which is stretched over a resonant body, the body. This sound membrane can be an animal skin, also parchment, a plastic film, paper, a mesh fabric or the like. The sound membrane can be made to vibrate in different ways. This is usually done by beating, for example in the case of a beating drum. In addition, friction drums are known, the sound membrane of which is stroked with an object or the hand.

Natural materials, e.g. animal skins or woven fabrics, and synthetic materials (plastics) are usually used for the production of the sound membranes. Natural materials are usually preferred over synthetic materials because the sounds they produce are warm sounds. When the sound membrane is used with, for example, a baton or a hand, a basic tone with minimal overtones is generated. The effect produced by the overtones is that of a significant disturbance of the sound and a reduction of its quality. In the case of a sound membrane made of a natural material, e.g. a woven material, the sound decay is relatively short, so that every note of a musical composition is easily perceptible.

Compared to natural materials, the sound of a sound membrane made of synthetic materials contains many dissonant overtones. The result is typically an unpleasant musical sound of indistinct tones. Despite these problems, synthetic sound membranes have a distinct advantage, including the strength of the material itself and its ability to withstand the negative effects of humidity and temperature.

Elastic mesh fabrics have a surface structure which makes these materials appear particularly suitable for producing different sound patterns of one and the same sound membrane or membranophone by causing the sound membrane to vibrate by striking and rubbing. The body has a great influence on the sound of a membranophone. In the case of a body which is light in relation to the sound membrane, part of the kinetic energy of the sound membrane is converted into low-frequency vibrations of the body. In the case of short bodies, low frequencies are attenuated because there is an acoustic short circuit. Some frequencies are amplified by resonance between the sound membrane air volume system in the body.

It is therefore an object of the present invention to provide a sound membrane with which a plurality of sound patterns can be generated without changing the tension of the sound membrane on the body.

It is also an object of the present invention to provide a membranophone, with which a plurality of sound patterns can be produced without changing the tension of the sound membrane on the body.

It is also an object of the present invention to provide a method for producing a sound membrane and/or a membranophone, with which a plurality of sound patterns can be produced without changing the tension of the sound membrane on the body.

This object is achieved by means of the sound membrane for use in a membranophone for producing sounds according to claim 1. Further advantageous configurations of the invention are set out in the dependent claims.

The inventive sound membrane is usually fastened to a body, which is designed as a resonant body, by means of, for example, a stretching frame. The sound membrane has a resonant surface. The resonant surface of the sound membrane is the flat region of the sound membrane which, when arranged on a resonance body (body), swings freely when the sound membrane is actuated, for example, by means of a beater, hand striking or stroking with the hand or an object. The resonant surface has a first region with a first haptic surface structure.

According to the invention, the resonant surface has a second region which has a structure different from the first region. The second region is arranged on the same side of the resonant surface as the first region, usually on the surface of the resonant surface. Optionally, the second region of the resonant surface is arranged on the side of the resonant surface which is opposite the side on which the first region is arranged.

When the sound membrane is actuated in the two different regions, two different vibration modes are therefore likewise produced in the sound membrane, depending on the design of the two regions, and two different sound patterns of the membranophone result from this. By means of a sound membrane, therefore, different sound patterns can be produced without the need to change the tension of the sound membrane, to change the actuating instrument or to arrange or actuate further additional components.

Optionally, the first region and the second region have a different surface structure. By striking with the hand or stroking with the hand or with an object, the different regions of the resonant surface likewise produce different sound patterns.

In a further embodiment of the invention, the upper side of the resonant surface has a second region, the upper side of the second region having a haptic surface structure different from the upper side of the first region. The surface of the resonant surface is the side of the resonant surface which is actuated and is arranged opposite the underside of the resonant surface. The underside of the resonant surface faces the resonance space formed by the body. The different haptics of the first and second regions result, for example, from the different coefficients of friction of the first and second regions.

In a further embodiment of the invention, the sound membrane has an elastic mesh fabric. The elastic mesh fabric forms part or the entire surface of the resonant surface and can be produced by means of weaving technology.

In a further advantageous embodiment of the invention, the structure of the mesh fabric in the first region of the resonant surface is different from the structure of the resonant surface in the second region of the sound membrane. The type of crossing of warp and weft threads in a fabric, the so-called weave, determines the structure of the mesh fabric. A large number of different types of weave are known, for example canvas, twill or satin fabric, zigzag twill, ridge twill, or rip. These differently designed weaves influence the properties of the mesh, in particular the modes of natural vibration of the mesh when the sound membrane is actuated. When the mesh fabric of the sound membrane is actuated, the sound membrane therefore produces different sound patterns.

In a further development of the invention, the sound membrane comprises woven textile. The woven textile has at least two types of thread (warp and weft), it being possible to produce a multiplicity of fabric variants, fabric thicknesses and surface structures by means of different weaving techniques.

In a further embodiment of the invention, the woven textile has a different weaving pattern in the first region of the resonant surface than the second region of the resonant surface. Different fabrics with, for example, stripe, check and jacquard patterns can be produced from composite weaves of at least two different weaves, which fabrics have different modes of natural vibration when the sound membrane is actuated. Optionally, the woven textile has a different woven structure in the first region of the resonant surface than in the second region of the resonant surface. The type of crossing of warp and weft threads in a fabric, the so-called weave, determines the weave structure of the mesh fabric. When the sound membrane is actuated in the different regions, the sound membrane therefore produces different sound patterns.

In an advantageous embodiment of the invention, the woven textile comprises woven elements, wherein the woven elements in the first region of the sound membrane are different from the woven elements in the second region of the sound membrane. The woven in elements are elements that change the haptics of the surface of the woven textile, e.g. sequins, press studs, beads. Optionally, the woven elements themselves generate a sound pattern, e.g. rattles or bells. Optionally, the elements are not woven into the woven textile, but are applied to the surface, for example by means of an adhesion material, sewn on as a patch, clipped on or arranged in another manner on the surface of the woven textile.

In a further embodiment of the invention, the woven textile in the first region of the sound membrane has a different yarn than the woven textile in the second region of the sound membrane. In this case, the yarns are different with respect, for example, to their yarn twist. In addition, twisted yarns can be used which consist of a plurality of yarns or yarn threads twisted together. Optionally, the yarn of the woven textile in the first region of the sound membrane has a different material than the yarn of the woven textile in the second region of the sound membrane. Natural materials such as linen, cotton, but also synthetic materials such as polyester are used. Also possible are fiber mixtures such as, for example, 50% cotton, 50% polyester. Optionally, the yarn of the woven textile in the first region of the sound membrane has a different yarn thickness than the yarn of the woven textile in the second region of the sound membrane. Optionally, the woven textile in the first region of the sound membrane has a different tension than the woven textile in the second region of the sound membrane. In particular, the first region and the second region are arranged on the sound membrane with a different tension. When one or more of the regions of the sound membrane are actuated, different vibration modes are therefore produced in the sound membrane, depending on the design of the regions.

In a further embodiment of the invention, the second region has a haptic surface structure which is different from the first region. The different haptics of the first and second regions result from the different coefficients of friction of the first and second regions. Upon actuation, in particular by stroking with the hand or with an object of one or more of the regions of the sound membrane, different vibration modes are therefore produced in the sound membrane depending on the design of the regions and, as a result, different sound patterns of the membranophone are produced.

In a further embodiment of the invention, one of the regions of the resonant surface has a shape which is different from a circular shape. While the resonant surface, like the sound membrane, usually has a circular shape, one or both regions of the resonant surface have different shapes, e.g. rectangular, oval, semicircular, etc. The regions can also have different shapes relative to one another in order to make optimum use of the available space of the resonant surface and/or to induce different characteristic vibration modes in the sound membrane when one or more of the regions of the sound membrane are actuated. In a further development of the invention, one of the regions of the resonant surface has an arrangement which deviates from a rotational symmetry about the center point of the sound membrane.

The stated object is furthermore achieved by means of the membranophone for generating tones.

The membranophone according to the invention for generating tones has a body and a sound membrane. In the playable state of the membranophone, the sound membrane is tensioned over the body.

The membranophone according to the invention has a sound membrane which is tensioned over a resonant body, the body. The body has a great influence on the sound pattern of a membranophone. In short bodies, low frequencies are attenuated because there is an acoustic short circuit. In addition frequencies are amplified by resonance between the sound membrane air volume system in the body. The combination sound membrane-body defines the sound pattern of the membranophone.

The sound membrane comprises an elastic mesh fabric. In addition, the sound membrane is coated on one side, optionally the sound membrane being uncoated on one side. Optionally, the coating is arranged on the underside of the sound membrane. Optionally, the resonant surface of the sound membrane is completely coated. Due to this advantageous embodiment, the surface structure of the elastic mesh fabric is covered only on one side, and the upper side of the sound membrane opposite the coating also has the surface structure of the elastic mesh fabric and can be made to sound in various ways (e.g. beating, rubbing). At the same time, the coating is designed to be elastic and stable in such a way that the sound membrane can be fastened to a body with a high tension.

In a further development, because of this arrangement of the coating, the top side and bottom side of the sound membrane are designed to be haptically different from one another. Due to the arrangement of the coating on only one side of the sound membrane, the surface structure of the elastic mesh fabric is covered only on one side, and the side opposite the coating still has the surface structure of the elastic mesh fabric. The different haptics result, for example, from the mutually different coefficients of friction of the coating and the elastic mesh fabric In a further development of the invention, the sound membrane comprises woven textile. The woven textile has at least two types of thread (warp and weft), it being possible to produce various fabric variants, fabric thicknesses and surface structures by means of different weaving techniques.

In a further development of the invention, the coating has a plurality of layers. The coating has a plurality of layers which differ from one another by, for example, layer thickness, modulus of elasticity and/or type of material in order to produce different sound patterns of the membranophone.

This object is also achieved by means of the method for producing a sound membrane and/or a membranophone for producing sounds. Further advantageous configurations of the invention are also set out in the dependent claims.

The method according to the invention for producing a sound membrane and/or a membranophone for producing sounds has two steps: In the first step, a first region of the resonant surface of the sound membrane is produced. In the second step, a second region of the resonant surface of the sound membrane is produced. The second region is arranged on the same side of the resonant surface as is the first region, usually on the surface of the resonant surface. Optionally, the second region of the resonant surface is arranged on the side of the resonant surface which is opposite the side on which the first region is arranged.

According to the invention, the first region of the resonant surface and the second region of the resonant surface have a different structure. When the sound membrane is actuated in the two different regions, two different vibration modes are therefore likewise produced in the sound membrane, depending on the design of the two regions, and two different sound patterns of the membranophone result from this. By means of a sound membrane, therefore, different sound patterns can be produced without the need to change the tension of the sound membrane, to change the actuating instrument or to arrange or actuate further additional components.

Optionally, the first region and the second region are produced in such a way that the two regions have a different surface structure. By striking with the hand or stroking with the hand or with an object, the different regions of the resonant surface likewise produce different sound patterns.

In a further embodiment of the invention, the upper side of the resonant surface has a second region, the upper side of the second region having a haptic surface structure different from the upper side of the first region. The surface of the resonant surface is the side of the resonant surface which is actuated and is arranged opposite the underside of the resonant surface. The underside of the resonant surface faces the resonance space formed by the body. The different haptics of the first and second regions result, for example, from the different coefficients of friction of the first and second regions.

In a further embodiment of the invention, a second region is arranged on the upper side of the resonant surface, the upper side of the second region having a haptic surface structure different from the upper side of the first region. The surface of the resonant surface is the side of the resonant surface which is actuated and is arranged opposite the underside of the resonant surface. The underside of the resonant surface faces the resonance space formed by the body. The different haptics of the first and second regions result, for example, from the different coefficients of friction of the first and second regions.

In a further embodiment of the invention, one of the regions of the resonant surface is produced in a shape different from a circular shape. While the resonant surface, like the sound membrane, usually has a circular shape, one or both regions of the resonant surface have different shapes, e.g. rectangular, oval, semicircular, etc. The regions can also have different shapes relative to one another in order to make optimum use of the available space of the resonant surface and/or to induce different characteristic vibration modes in the sound membrane when one or more of the regions of the sound membrane are actuated. In a further development of the invention, one of the regions of the resonant surface is produced with an arrangement which deviates from a rotational symmetry about the center point of the sound membrane.

In a further embodiment of the invention, the sound membrane is produced in the form of an elastic mesh fabric. The elastic mesh fabric forms part or the entire surface of the resonant surface and is produced by means of weaving technology.

In a further advantageous embodiment of the invention, the structure of the mesh fabric in the first region of the resonant surface is produced different from the structure of the resonant surface in the second region of the sound membrane. The type of crossing of warp and weft threads in a fabric, the so-called weave, determines the structure of the mesh fabric. A large number of different types of weave are known, for example canvas, twill or satin fabric, zigzag twill, ridge twill, or rip. These differently designed weaves influence the properties of the mesh, in particular the modes of natural vibration of the mesh fabric when the sound membrane is actuated. When the mesh fabric of the sound membrane is actuated, the sound membrane therefore produces different sound patterns.

In a further development of the invention, the sound membrane is produced as a woven textile. The woven textile has at least two types of thread (warp and weft), it being possible to produce a multiplicity of fabric variants, fabric thicknesses and surface structures by means of different weaving techniques.

In a further embodiment of the invention, the woven textile has a different weaving pattern in the first region of the resonant surface than the second region of the resonant surface. Different fabrics with, for example, stripe, check and jacquard patterns can be produced from composite weaves of at least two different weaves, which fabrics have different modes of natural vibration when the sound membrane is actuated. Optionally, the woven textile is produced with a different woven structure in the first region of the resonant surface than in the second region of the resonant surface. The type of crossing of warp and weft threads in a fabric, the so-called weave, determines the weave structure of the mesh fabric. When the sound membrane is actuated in the different regions, the sound membrane therefore produces different sound patterns.

In an advantageous embodiment of the invention, woven elements are woven into the woven textile, wherein the woven elements in the first region of the sound membrane are different from the woven elements in the second region of the sound membrane. The woven elements are elements that change the haptic of the surface of the woven textile, e.g. sequins, press studs, beads. Optionally, the woven elements themselves generate a sound pattern, e.g. rattles or bells. Optionally, the elements are not woven into the woven textile, but are applied to the surface, for example by means of an adhesion material, or sewn on as a patch, clipped on or arranged in another manner on the surface of the woven textile.

In a further embodiment of the invention, the woven textile in the first region of the sound membrane is produced with a different yarn than the woven textile in the second region of the sound membrane. In this case, the yarns are different with respect, for example, to their yarn twist. In addition, twisted yarns can be used which consist of a plurality of yarns or yarn threads twisted together. Optionally, the yarn of the woven textile in the first region of the sound membrane has a different material than the yarn of the woven textile in the second region of the sound membrane. Natural materials such as linen, cotton, wool, but also synthetic materials such as polyester are used. Also possible are fiber mixtures such as, for example, 50% cotton, 50% polyester. Optionally, the yarn of the woven textile in the first region of the sound membrane has a different yarn thickness than the yarn of the woven textile in the second region of the sound membrane. Optionally, the woven textile in the first region of the sound membrane has a different tension than the woven textile in the second region of the sound membrane. In particular, the first region and the second region are arranged on the sound membrane with a different tension. When one or more of the regions of the sound membrane are actuated, different vibration modes are therefore produced in the sound membrane, depending on the design of the regions.

The membranophone according to the invention for generating sounds has a body and a sound membrane. In the playable state of the membranophone, the sound membrane is tensioned over the body.

Exemplary embodiments of the sound membrane according to the invention, of the membranophone according to the invention and of the method according to the invention for producing a sound membrane and/or a membranophone are shown schematically in simplified form in the drawings and are explained in more detail in the following description.

In the drawings:

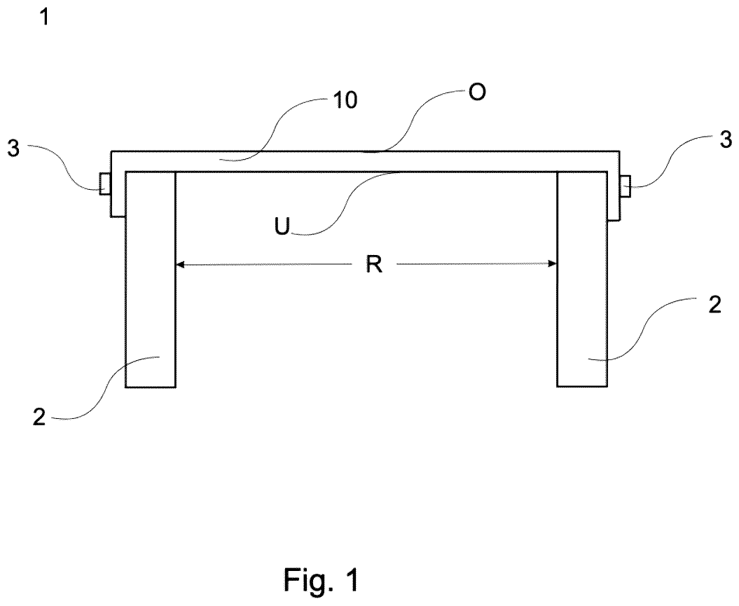

FIG. 1 shows a sectional view of a membranophone according to the invention

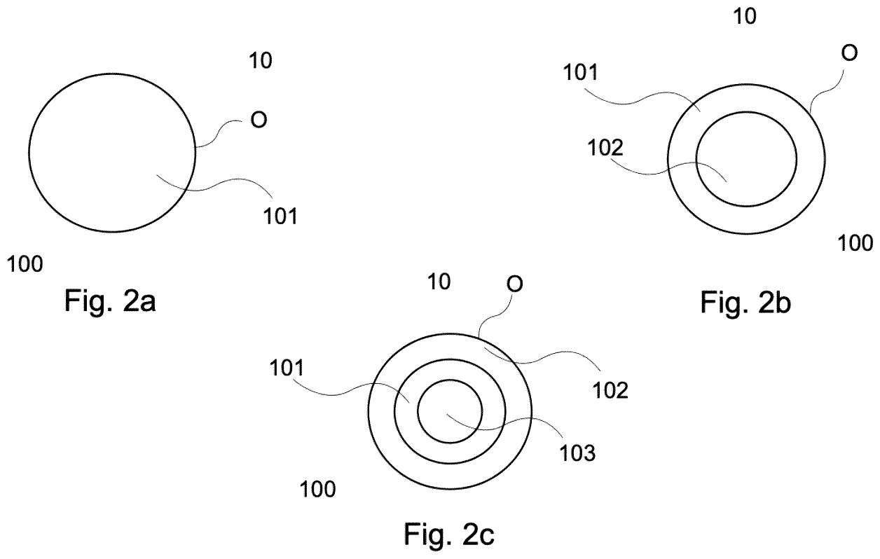

FIG. 2a shows a top view of a sound membrane, a region of the mesh fabric

FIG. 2b shows a top view of a sound membrane, two different concentric regions of the mesh fabric

FIG. 2c shows a top view of a sound membrane, three different concentric regions of the mesh fabric

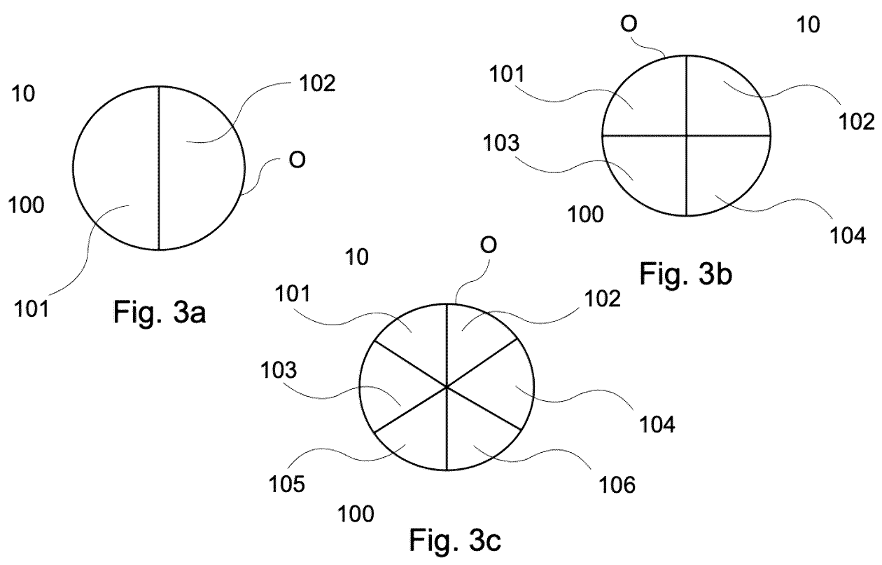

FIG. 3a shows a top view of a sound membrane, two different regions of the mesh fabric

FIG. 3b shows a top view of a sound membrane, four different regions of the mesh fabric

FIG. 3c: shows a top view of a sound membrane, six different regions of the mesh fabric

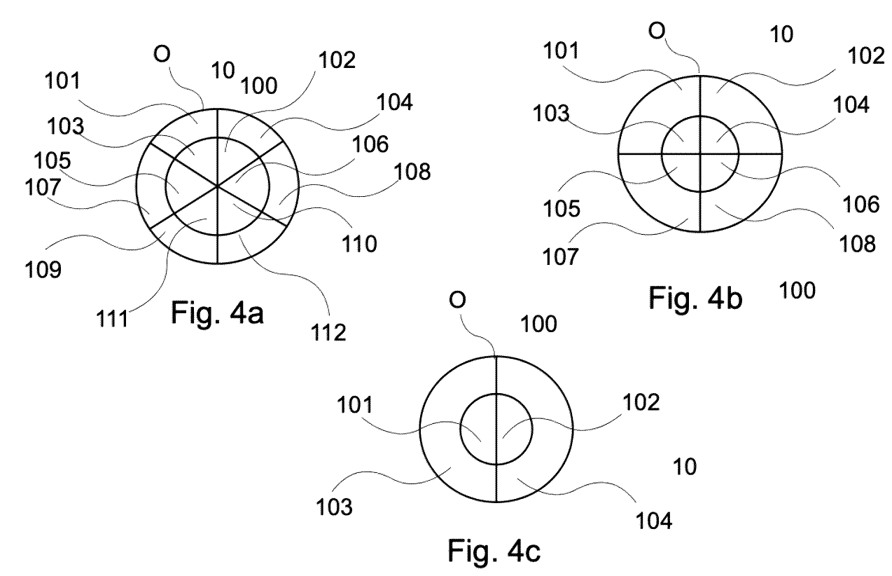

FIG. 4a shows a top view of a sound membrane, two different regions of the mesh fabric

FIG. 4b shows a top view of a sound membrane, four different regions of the mesh fabric

FIG. 4c shows a top view of a sound membrane, six different regions of the mesh fabric

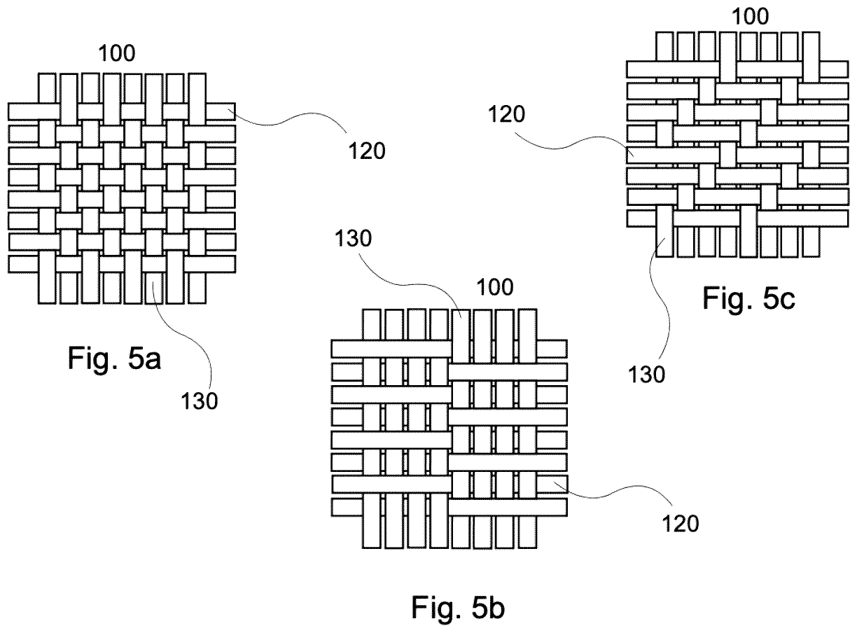

FIG. 5a shows a top view of a mesh fabric

FIG. 5b shows a top view of a further mesh fabric

FIG. 5c shows a top view of a further mesh fabric

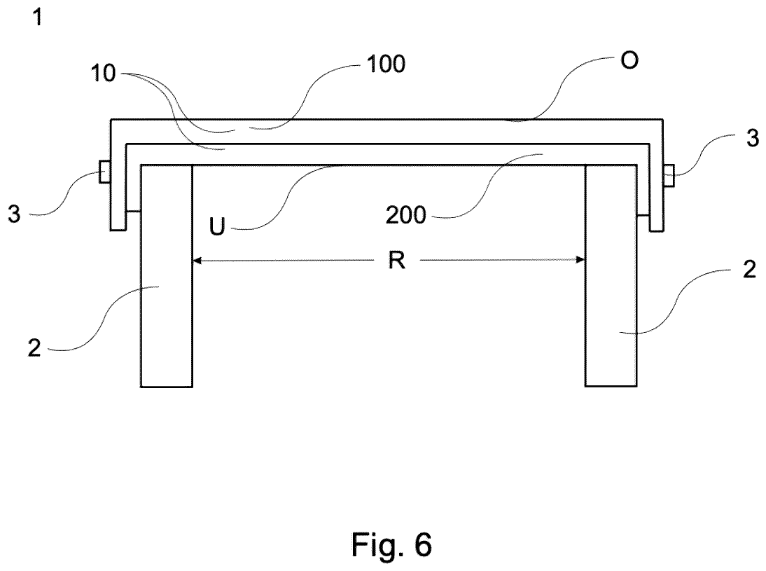

FIG. 6 shows a sectional view of a membranophone according to the invention, with sound membrane coated on the underside

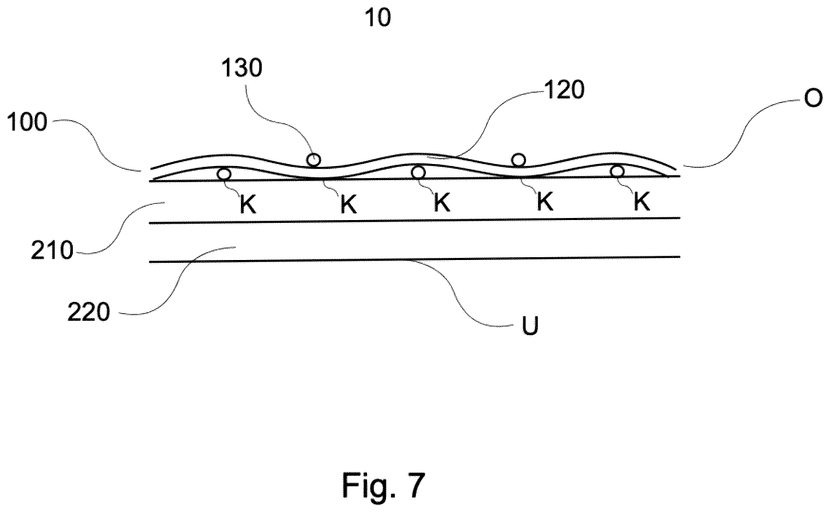

FIG. 7 shows a sectional view of a sound membrane according to the invention, with sound membrane coated with two layers on the underside

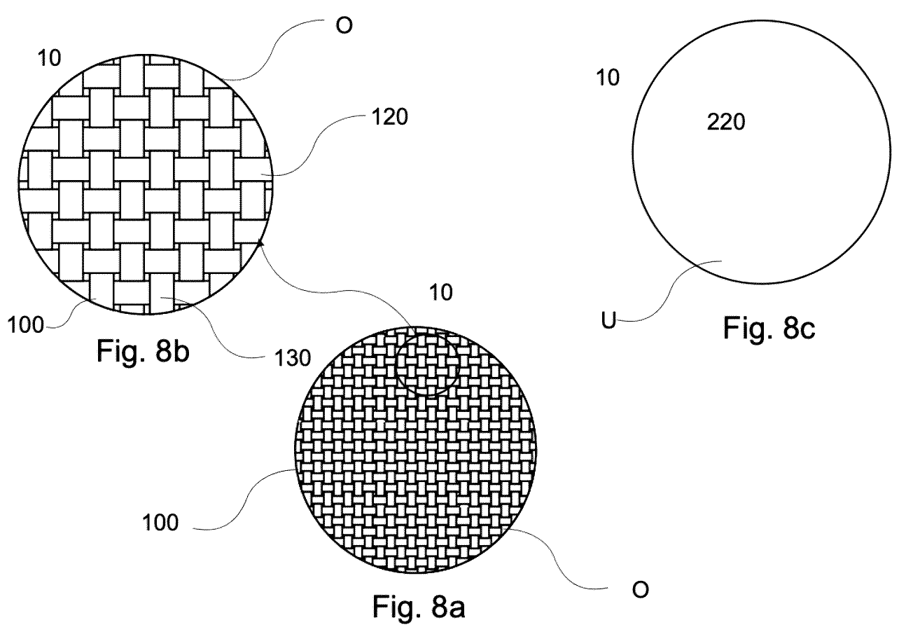

FIG. 8a shows a top view of a mesh fabric

FIG. 8b shows a detailed view of an exemplary embodiment of a mesh fabric

FIG. 8c shows a view of the underside of a sound membrane

FIG. 1 shows a sectional view of an exemplary embodiment of a membranophone 1 according to the invention. The membranophone 1 has the sound membrane 10 which is tensioned on the upper edge of the body 2 by means of a tensioning device 3, for example a tensioning hoop and tuning screws extending around the upper edge of the body 2, in such a way that the underside U of the sound membrane 10 faces the resonance space formed by the body 2. The surface region of the sound membrane 10, which is not arranged on and above the upper edge of the body 2, forms the resonant surface R of the sound membrane 10. The resonant surface R is accordingly the region of the sound membrane 10 which, when the upper side O of the sound membrane 10 is actuated, swings freely by, for example, a beater, striking by hand or stroking by hand or an object.

FIG. 2 shows top views of the upper side O of different exemplary embodiments of the inventive sound membrane 10. In this exemplary embodiment, the sound membrane 10 has a mesh fabric 100 which is designed as a woven textile. The mesh fabric 100 has different regions 101, 102, 103.

The individual different regions 101, 102, 103 differ by the type of weaving technique of the mesh fabric 100 (cf. FIG. 5) from each other. When one or more of the regions 101, 102, 103 of the sound membrane 10 is actuated, different vibration modes are therefore produced in the sound membrane 10, depending on the design of the regions 101, 102, 103, and, as a result, different sound patterns of the membranophone 1 are produced. In particular, the individual different regions 101, 102, 103 therefore have surface structures which are different from one another, in particular haptically different.

In this exemplary embodiment, up to three mutually different regions 101, 102, 103 of the mesh fabric 100 are arranged concentrically, the center of the regions 101, 102, 103 being formed with the center of the circular sound membrane 10. The inventive sound membrane 10 can have only a single region 101 (FIG. 2a), and the mesh fabric 100 is thus homogeneous over the entire upper side O of the sound membrane 10. The mesh fabric 100 can also have two different regions 101, 102 (FIG. 2b) or three different regions 101, 102, 103 (FIG. 2c).

Top views of the upper side O of further different exemplary embodiments of the inventive sound membrane 10 are shown in FIG. 3. The mesh fabric 100 has different regions 101, 102, 103, 104, 105, 106, which in this exemplary embodiment are arranged in equally large segments. The sound membrane 10 has two different regions 101, 102 (FIG. 3a), four different regions 101, 102, 103, 104 (FIG. 3b) and six different regions 101, 102, 103, 104, 105, 106 (FIG. 3c). The different regions 101, 102, 103, 104, 105, 106 have a shape different from the circular shape for optimum utilization of the space on the sound membrane 10.

FIG. 4 shows top views of the upper side O of different exemplary embodiments of the inventive sound membrane 10, the different regions 101, 102, 103, 104, 105, 106, 107, 108, 109, 110, 111, 112 being arranged both concentrically and segmented in these exemplary embodiments. The sound membrane 10 has twelve different regions 101, 102, 103, 104, 105, 106, 107, 108, 109, 110, 111, 112 (FIG. 4a), eight different regions 101, 102, 103, 104, 105, 106, 107, 108 (FIG. 4b) or four different regions 101, 102, 103, 104 (FIG. 4c).

FIG. 5 shows top views of exemplary embodiments of differently designed mesh fabrics 100. The three mesh fabrics 100 shown here are designed as a woven textile, i.e. are produced by means of weaving technology. The mesh fabric 100 has two thread systems (warp and weft), which are referred to in this document as transverse thread system 120 and longitudinal thread system 130. Both thread systems 120, 130 have the same thread. The thread systems 120, 130 intersect at a right angle, the thread systems 120, 130 in these exemplary embodiments have the same fineness and the same type of yarn with respect to one another. Thread systems 120, 130 with differently designed threads are conceivable.

In addition, the different regions 101, 102, 103 can differ from one another in the weaving pattern and in the weaving structure, wherein different vibration modes are also generated when the upper side O of the sound membrane 10 is actuated by, for example, a beater, by striking with the hand or stroking with the hand or an object. The different regions 101, 102, 103 can also be produced with a different yarn, the yarn having different thickness and/or different material. During the manufacturing process, the tension with which the regions 101, 102, 103 are woven can also be varied.

The weave, i.e. the type of crossing of the two thread systems 120, 130, is in each case designed differently from one another in these exemplary embodiments. The weave in FIG. 5a shows a so-called plain weave in such a way that a transverse thread 120 runs alternately under a longitudinal thread 130, and conversely a longitudinal thread 130 runs under a transverse thread 120. FIG. 5b and FIG. 5c show differently woven rib weaves. The transverse threads 120 cover four longitudinal threads (FIG. 5b) or three longitudinal threads (FIG. 5c). Further weaves of the thread systems 120, 130 are conceivable.

These differently designed weaves influence the properties of the mesh fabric 100, in particular the modes of natural vibration of the mesh fabric 100 when the sound membrane 10 is actuated. In an advantageous embodiment of the invention, the woven textile comprises woven in elements, wherein the woven elements in the first region of the sound membrane are different from the woven elements in the second region of the sound membrane. The woven elements are elements that change the haptic of the surface of the woven textile, e.g. sequins, press studs, beads. Optionally, the woven elements themselves generate a sound pattern, e.g. rattles or bells. Optionally, the elements are not woven into the woven textile, but are applied to the surface, for example by means of an adhesion material, sewn on as a patch, clipped on or arranged in another manner on the surface of the woven textile.

FIG. 6 shows a sectional view of an exemplary embodiment of a membranophone 1 according to the invention (cf. FIG. 1) The membranophone 1 has the sound membrane 10, which is tensioned to the upper edge of the body 2 by means of a tensioning device 3 in such a way that the underside U of the sound membrane 10 faces the resonance space formed by the body 2.

The upper side O of the sound membrane 10 has the elastic mesh fabric 100. The coating 200 is arranged on the underside U of the sound membrane 10 (cf. FIGS. 7, 8). The coating 200 is arranged on the underside U of the sound membrane 10 in such a way that at least the resonant surface R is covered over its entire surface with the coating 200. In this exemplary embodiment, a larger region than the resonance region R is provided with the coating 200. The tensioning device 3 thus tensions and fixes not only the elastic mesh fabric 100 but also the coating 200.

### LIST OF REFERENCE NUMERALS

1 membranophone
2 body
3 tensioning device
10 sound membrane
100 mesh fabric
101, 102, 103, 104, different regions of the mesh fabric
105, 106, 107, 108,
109, 110, 111, 112
120 transverse thread system
130 longitudinal thread system
200 coating
210 layer with adhesive material
220 film
K contact point
O upper side of the sound membrane
U underside of the sound membrane
R resonant surface of the sound membrane

1. A sound membrane (10) for use in a membranophone (1) for generating sounds having a resonant surface (R), wherein said resonant surface (R) has a first region (101) having a first haptic surface structure,
characterized in that
the resonant surface (R) has a second region (102),
wherein the second region (102) has a structure different from the first region (101).

2. The sound membrane (10) for use in a membranophone (1) for generating sounds according to claim 1,
characterized in that
the resonant surface (R) in the second region (102) has a surface structure that is different from the first region (101).

3. The sound membrane (10) for use in a membranophone (1) for generating sounds according to claim 1,
characterized in that
the upper side (O) of the resonant surface (R) has a second region (102),
wherein the upper side of the second region (102) of the resonant surface (R) has a haptic surface structure different from the upper side of the first region (101).

4. The sound membrane (10) for use in a membranophone (1) for
generating sounds according to claim 1,
characterized in that
the sound membrane (10) has an elastic mesh fabric (100).

5. The sound membrane (10) for use in a membranophone (1) for generating sounds according to claim 1,
characterized in that
the structure of the mesh fabric (100) in the first region (101) of the resonant surface (R) is different from the structure of the resonant surface (R) in the second region (102) of the sound membrane (10).

6. The sound membrane (10) for use in a membranophone (1) for generating sounds according to claim 1,
characterized in that
the sound membrane (10) comprises a woven textile.

7. The sound membrane (10) for use in a membranophone (1) for generating sounds according to claim 6,
characterized in that
the woven textile has a different weaving pattern in the first region (101) of the resonant surface (R) than in the second region (102) of the resonant surface (R).

8. The sound membrane (10) for use in a membranophone (1) for generating sounds according to claim 6,
characterized in that
the woven textile has a different weaving structure in the first region (101) of the resonant surface (R) than in the second region (102) of the resonant surface (R).

9. The sound membrane (10) for use in a membranophone (1) for generating sounds according to claim 6,
characterized in that
the woven textile comprises woven elements,
wherein the woven elements in the first region (101) of the sound membrane (10) are different from the woven elements in the second region (102) of the sound membrane (10).

10. The sound membrane (10) for use in a membranophone (1) for generating sounds according to claim 6,
characterized in that
the woven textile in the first region (101) of the sound membrane (10) has a different yarn than the woven textile in the second region (102) of the sound membrane (10).

11. The sound membrane (10) for use in a membranophone (1) for generating sounds according to claim 10,
characterized in that
the yarn of the woven textile in the first region (101) of the sound membrane (10) has a different material than the yarn of the woven textile in the second region (102) of the sound membrane (10).

12. The sound membrane (10) for use in a membranophone (1) for generating sounds according to claim 11,
characterized in that
the yarn of the woven textile in the first region (101) of the sound membrane (10) has a different yarn thickness than the yarn of the woven textile in the second region (102) of the sound membrane (10).

13. The sound membrane (10) for use in a membranophone (1) for generating sounds according to claim 6,
characterized in that
the woven textile in the first region (101) of the sound membrane (10) has a different tension than the woven textile in the second region (102) of the sound membrane (10).

14. The sound membrane (10) for use in a membranophone (1) for generating sounds according to claim 1,
characterized in that
the second region (102) has a surface structure that is haptically different from the first region (101).

15. The sound membrane (10) for use in a membranophone (1) for generating sounds according to claim 1,
characterized in that
one of the regions (101, 102) of the resonant surface (R) has a shape which is different from a circular shape.

16. The sound membrane (10) for use in a membranophone (1) for generating sounds according to claim 1,
characterized in that
one of the regions (101, 102) of the resonant surface (R) has an arrangement deviating from a rotational symmetry about the center of the sound membrane (10).

17. The membranophone (1) for generating sounds with a body (2) and a sound membrane (10) according to claim 1,
wherein the sound membrane (10) comprises an elastic mesh fabric (100),
wherein the sound membrane (10) is coated on one side.

18. A method for producing a sound membrane (10) and/or a membranophone (1) for producing sounds, comprising the steps
producing a first region (101) of the resonant surface (R) of the sound membrane (10)
producing a second region (101) of the resonant surface (R) of the sound membrane (10)
wherein the first region (101) of the resonant surface (R) has a structure different from the second region (102) of the resonant surface (R).

19. The method for producing a sound membrane (10) and/or a membranophone (1) for generating sounds according to claim 18,
characterized in that
the first region (101) of the resonant surface (R) is produced with a surface structure that is different from the second region (102) of the resonant surface (R).

20. The method for producing a sound membrane (10) and/or a membranophone (1) for generating sounds according to claim 19,
characterized in that
the first region (101) of the resonant surface (R) is produced with a haptic surface structure that is different from the second region (102) of the resonant surface (R).

21. The method for producing a sound membrane (10) and/or a membranophone (1) for generating sounds according to claim 18,
characterized in that
a second region (102) is arranged on the upper side (O) of the resonant surface (R),
wherein a haptic surface structure different from the upper side of the first region (101) of the resonant surface (R) is produced on the upper side of the second region (102) of the resonant surface (R).

22. The method for producing a sound membrane (10) and/or a membranophone (1) for generating sounds according to claim 18,
characterized in that
the first region (101) of the resonant surface (R) is produced in a shape different from a circular shape.

23. The method for producing a sound membrane (10) and/or a membranophone (1) for generating sounds according to claim 18,
characterized in that
the first region (101) of the resonant surface (R) is produced in an arrangement deviating from a rotational symmetry about the center of the sound membrane (10).

24. The method for producing a sound membrane (10) and/or a membranophone (1) for generating sounds according to claim 18,
characterized in that
the sound membrane (10) is produced in the form of an elastic mesh fabric (100).

25. The method for producing a sound membrane (10) and/or a membranophone (1) for generating sounds according to claim 24,
characterized in that
a structure of the mesh fabric (100) is produced in the first region (101) of the resonant surface (R) which is different from the structure of the resonant surface (R) in the second region (102) of the sound membrane (10).

26. The method for producing a sound membrane (10) and/or a membranophone (1) for generating sounds according to claim 18,
characterized in that
the sound membrane (10) is produced as a woven textile.

27. The method for producing a sound membrane (10) and/or a membranophone (1) for generating sounds according to claim 26,
characterized in that
the woven textile is woven in a different weaving pattern in the first region (101) of the resonant surface (R) than in the second region (102) of the resonant surface (R).

28. The method for producing a sound membrane (10) and/or a membranophone (1) for generating sounds according to claim 26,
characterized in that
the woven textile is woven with a different weaving structure in the first region (101) of the resonant surface (R) than in the second region (102) of the resonant surface (R).

29. The method for producing a sound membrane (10) and/or a membranophone (1) for generating sounds according to claim 26,
characterized in that
elements are woven into the first region (101) of the resonant surface (R) of the sound membrane (10).

30. The method for producing a sound membrane (10) and/or a membranophone (1) for generating sounds according to claim 29,
characterized in that
different elements are woven into the first region (101) of the resonant surface (R) of the sound membrane (10) than into the second region (102) of the resonant surface (R).

31. The method for producing a sound membrane (10) and/or a membranophone (1) for generating sounds according to claim 26,
characterized in that
the woven textile in the first region (101) of the sound membrane (10) is woven with a different yarn than the woven textile in the second region (102) of the sound membrane (10).

32. The method for producing a sound membrane (10) and/or a membranophone (1) for generating sounds according to claim 31,
characterized in that
the woven textile is woven with a yarn of different material in the first region of the sound membrane than the woven textile in the second region of the sound membrane.

33. The method for producing a sound membrane (10) and/or a membranophone (1) for generating sounds according to claim 32,
characterized in that
the yarn of the woven textile in the first region (101) of the sound membrane (10) has a different yarn thickness than the yarn of the woven textile in the second region (102) of the sound membrane (10).

34. The method for producing a sound membrane (10) and/or a membranophone (1) for generating sounds according to claim 26,
characterized in that
the woven textile in the first region (101) of the sound membrane (10) is woven with a different tension than the woven textile in the second region (102) of the sound membrane (10).

35. The method for producing a sound membrane (10) and/or a membranophone (1) for generating sounds according to claim 26,
characterized in that
the membranophone (1) is covered with the sound membrane (10).
